(19) United States
(12) Patent Application Publication
(10) Pub. No.: US 2006/0228438 A1
(43) Pub. Date: Oct. 12, 2006

(54) Supporting device for movable portion and die clamping unit

(75) Inventors: Jun Koike, Shizuoka-ken (JP); Takaki Miyauchi, Shizuoka-ken (JP); Noriyuki Sasaki, Shizuoka-ken (JP)

Correspondence Address: DLA PIPER RUDNICK GRAY CARY US LLP, P. O. BOX 9271, RESTON, VA, 20195, US

(73) Assignee: TOSHIBA KIKAI KABUSHIKI KAISHA, TOKYO (JP)

(21) Appl. No.: 11/392,765

(22) Filed: Mar. 30, 2006

(30) Foreign Application Priority Data
Apr. 8, 2005 (JP) 2005-112504

(51) Int. Cl. B29C 45/54

(52) U.S. Cl. 425/472

(57) ABSTRACT

A supporting device according to the embodiment comprises a linear guide and a mounting base configured to move linearly, guided by the linear guide, a movable portion mounted on the mounting base, a servomotor having a ball screw which causes the mounting base to move the movable portion linearly, and a plurality of wedges located between the movable portion and the mounting base in front of and/or at the back of the movable portion and configured to adjust inclinations of the movable portion in an up-down direction and in a left-right direction within a horizontal plane.

### CROSS-REFERENCE TO RELATED APPLICATIONS

This application is based upon and claims the benefit of priority from prior Japanese Patent Application No. 2005-112504, filed Apr. 8, 2005, the entire contents of which are incorporated herein by reference.

### BACKGROUND OF THE INVENTION

1. Field of the Invention

The present invention relates to a movable portion supporting device for supporting a movable die and a die clamping unit, in an injection molding machine or the like in which a liquid resin is injected into injection molding dies to form a molded product.

2. Description of the Related Art

FIGS. 8 and 9 show an example of an injection molding machine in which a liquid resin is injected into injection molding dies to form a molded product. This injection molding machine comprises a die clamping frame 41, a stationary portion 43, a movable portion 45, and a movable die 46. The stationary portion 43 is provided on the upper surface of the frame 41 and fitted with a stationary die 42. The movable portion 45 is attached to the stationary portion 43 for advance and retreat by tie bars 44. The movable die 46 is provided on the movable portion 45 for advance and retreat with respect to the stationary die 42.

Slide plates 47, which are formed of a belt-shaped steel plate with low frictional resistance each, are provided individually on the opposite sides, left and right, of the upper surface of the die clamping frame 41. The slide plates 47 support the movable portion 45 for linear movement in a Z-axis direction by means of wedge holders 48. Further, hydraulic cylinders 49 are located individually on the opposite sides of die clamping frame 41. Respective rods 50 of the cylinders 49 are coupled individually to the opposite side portions of the wedge holders 48 that support the movable portion 45. In a die clamping operation, the hydraulic cylinders 49 cause the movable portion 45 to move the movable die 46, whereby a die clamping force for the stationary die 42 can be obtained.

The wedge holders 48 extend in the die opening and closing direction and are fixed. The holders 48 receive a moment to urge the movable portion 45 to fall, thereby keeping the movable portion 45 parallel to the stationary portion 43 as the dies are opened or closed.

The respective rods 50 of the hydraulic cylinders 49 are coupled to the lower end part of the movable portion 45. If the movable portion 45 is moved by the cylinders 49, thereby clamping the movable die 46 to the stationary die 42, therefore, the movable portion 45 inclines in an up-down direction. If the pair of hydraulic cylinders 49 are driven with a time lag, moreover, the movable portion 45 inclines in a left-right direction (vertical direction of FIG. 8). If the hydraulic cylinders 49 move the movable portion 45 with a strong force so that the movable die 46 is clamped to the stationary die 42, furthermore, the outer peripheral edge of the movable portion 45 is deformed toward the stationary portion 43. On the other hand, the outer peripheral edge of the stationary portion 43 is deformed toward the movable portion 45. Thus, each of the stationary and movable portions 43 and 45 is deformed substantially into the shape of a circular arc as viewed both laterally and flat.

In consideration of these circumstances, a technique is proposed such that wedges are used as means for adjusting the stationary and movable portions 43 and 45 to be parallel to each other, thereby smoothing die opening and closing strokes to prevent breakage or abrasion of the dies.

More specifically, as also shown in FIGS. 10 and 11, first wedges 51a and 51b are located on respective lower surfaces 48a of the left- and right-hand wedge holders 48, respectively, in front of the movable portion 45. Further, second wedges 52a and 52b are located at the back of the movable portion 45. The first wedges 51a and 51b and the second wedges 52a and 52b are inserted between the slide plates 47 and the wedge holders 48. By adjusting the depth of insertion of the first wedges 51a and 51b , therefore, the movable portion 45 can be inclined in a rotation direction around the Z-axis and a rotation direction around an X-axis. Likewise, by adjusting the depth of insertion of the second wedges 52a and 52b , the movable portion 45 can be inclined in the rotation direction around the Z-axis and the rotation direction around the X-axis. Thus, the movable portion 45 and the stationary portion 43 can be kept parallel to each other to smooth the die opening and closing strokes and protect the dies. Furthermore, the sliding resistance between the movable portion 45 and the tie bars 44 can be regulated by simultaneously adjusting the depths of insertion of the first wedges 51a and 51b and the second wedges 52a and 52b and moving the movable portion 45 up and down in the direction of a Y-axis.

Further, third wedges 53a and 53bare located on respective side surfaces 48b of the left- and right-hand wedge holders 48, respectively, in front of the movable portion 45, and fourth wedges 54a and 54b at the back. The third wedges 53a and 53band the fourth wedges 54a and 54b are inserted between the slide plates 47 and the wedge holders 48. By adjusting the depth of insertion of the third wedges 53a and 53b, therefore, the movable portion 45 can be inclined in a rotation direction around the Y-axis. Likewise, by adjusting the depth of insertion of the fourth wedges 54a and 54b, the movable portion 45 can be inclined in the rotation direction around the Y-axis. Thus, the parallelism with the stationary portion 43 can be maintained to smooth the die opening and closing strokes and protect the dies.

In the injection molding machine described above, the movable portion 45 can be inclined in the rotation direction around the X-axis by adjusting the depth of insertion of the first wedges 51a and 51b. At the same time, however, the movable portion 45 also moves in the Y-axis direction, so that its height changes inevitably. Thus, in the aforementioned arrangement, the movement of the movable portion 45 in the Y-axis direction and the X-axis rotation thereof cannot be adjusted independently of each other.

This invention has been made in consideration of these circumstances, and its object is to provide a supporting device for a movable portion and a die clamping unit, configured so that a movable portion can be easily, independently adjusted in an up-down direction and a left-right direction.

### BRIEF SUMMARY OF THE INVENTION

A supporting device for a movable portion according to an aspect of the present invention comprises: a linear guide and a mounting base configured to move linearly, guided by the linear guide; the movable portion mounted on the mounting base; a servomotor having a ball screw which causes the mounting base to move the movable portion linearly; and a plurality of adjusting mechanism located between the movable portion and the mounting base in front of and/or at the back of the movable portion and configured independently to adjust inclinations of the movable portion in an up-down direction and in a left-right direction within a horizontal plane.

In a supporting device for a movable portion according to another aspect of the invention, the adjusting mechanisms are wedges which are inserted between the movable portion and the mounting base and serve to adjust the inclinations of the movable portion in the up-down direction and in the left-right direction within the horizontal plane, depending on the depth of the insertion.

In a supporting device for a movable portion according to a further aspect of the invention, the adjusting mechanisms include wedges which are inserted between the movable portion and the mounting base and serve to adjust the inclinations of the movable portion in the up-down direction and in the left-right direction within the horizontal plane, depending on the depth of the insertion, and elastic pressure members which are opposed to the wedges and elastically press the movable portion toward the mounting base.

In a supporting device for a movable portion according to a further aspect of the invention, the wedges include first and second wedges which are located individually in front and at the back of the movable portion and serve to adjust the inclination of the movable portion in the up-down direction and third wedge which are located in front or at the back of the movable portion and serve to adjust the inclination of the movable portion and in the left-right direction within the horizontal plane.

A supporting device for a movable portion according to an additional aspect of the invention includes die clamping means having a stationary portion fitted with a stationary die and a movable portion attached to the stationary portion by a tie bar and configured to move the movable portion to advance or retreat a movable die fixed to the movable portion with respect to the stationary die, thereby generating a die clamping force, comprising: a linear guide and a mounting base configured to move linearly, guided by the linear guide; the movable portion mounted on the mounting base; a servomotor having a ball screw which causes the mounting base to move the movable portion linearly; and a plurality of adjusting mechanism located between the movable portion and the mounting base in front of and/or at the back of the movable portion and configured independently to adjust inclinations of the movable portion in an up-down direction and in a left-right direction within a horizontal plane.

A supporting device for a movable portion according to another aspect of the invention has the movable portion which is mounted on a mounting base configured to move linearly, guided by a linear guide, and is supported for linear movement by a servomotor having a ball screw, comprising a plurality of adjusting mechanism located between the movable portion and the mounting base in front of and/or at the back of the movable portion and configured independently to adjust inclinations of the movable portion in an up-down direction and in a left-right direction within a horizontal plane.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a side view of a die clamping unit of a hybrid injection molding machine according to a first embodiment of the invention;

FIG. 2 is a plan view of the die clamping unit of the embodiment;

FIG. 3 is a sectional view of the embodiment taken along line A-A of FIG. 1;

FIG. 4A is a plan view of a wedge mechanism of the embodiment;

FIG. 4B is a side view of the wedge mechanism of the embodiment;

FIG. 5A is a plan view of the wedge mechanism of the embodiment;

FIG. 5B is a side view of the wedge mechanism of the embodiment;

FIG. 6 is a side view of a first elastic pressure member of the embodiment;

FIG. 7 is a plan view of a second elastic pressure member of the embodiment;

FIG. 8 is a plan view of a die clamping unit of a conventional injection molding machine;

FIG. 9 is a side view of the die clamping unit of the conventional injection molding machine;

FIG. 10 is a view taken in the direction of arrow B of FIG. 8; and

FIG. 11 is a view taken in the direction of arrow C of FIG. 8.

### DETAILED DESCRIPTION OF THE INVENTION

An embodiment of this invention will now be described with reference to the accompanying drawings.

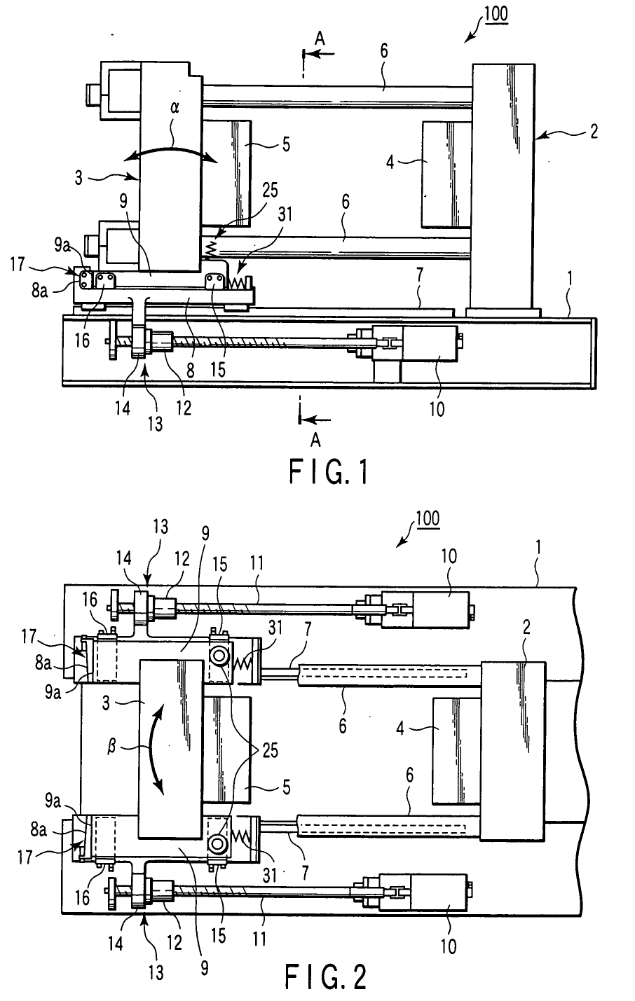

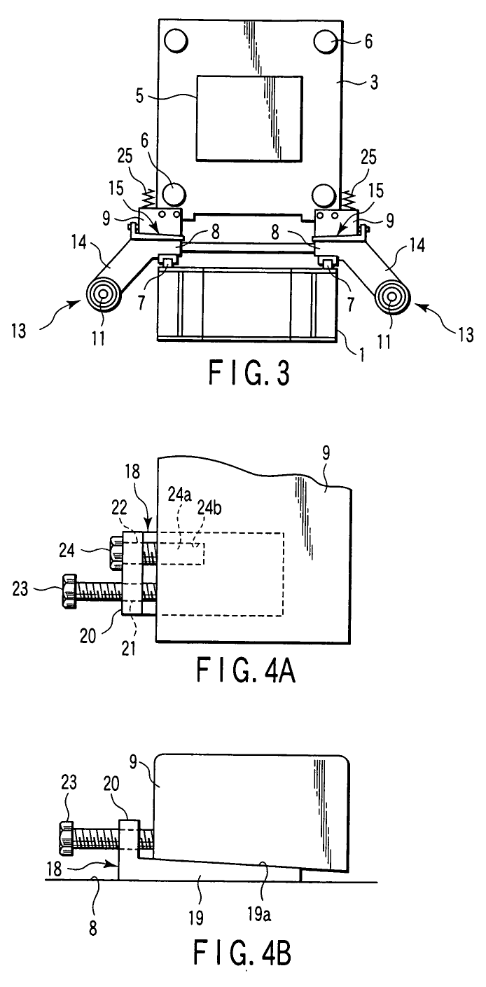

FIGS. 1 to 7 show a first embodiment, in which FIG. 1 is a side view of a die clamping unit of a hybrid injection molding machine, FIG. 2 is a plan view, and FIG. 3 is a sectional view taken along line A-A of FIG. 1.

As shown in FIGS. 1 to 3, a die clamping frame 1 is provided with a stationary portion 2 and a movable portion 3. A stationary die 4 is attached to the stationary portion 2. The movable portion 3 is fitted with a movable die 5, which faces the stationary die 4. A plurality of tie bars 6 protrude from the stationary portion 2. The tie bars 6 support the movable portion 3 for advance and retreat with respect to the stationary portion 2.

A pair of linear guides 7, left and right, are provided on the die clamping frame 1. The linear guides 7 individually support a pair of mounting bases 8 for linear movement. A separate movable portion supporting member 9 is movably mounted on each mounting base 8. The movable portion 3 is fixed to the supporting members 9. Thus, the mounting bases 8 are guided individually by the linear guides 7 as they move linearly. The movable portion 3 and the movable portion supporting members 9 are integral with one another and are guided by the tie bars 6 as they move linearly.

Servomotors 10 are located individually on the left- and right-hand sides of the die clamping frame 1. The respective rotating shafts of the servomotors 10 are provided individually with thread portions 11 that extend parallel to the pair of linear guides 7. A nut portion 12 is threadedly fitted on each thread portion 11, thereby forming a ball screw 13. The nut portion 12 of each ball screw 13 is fixed to a mounting portion 14 that protrudes integrally outward from each mounting base 8.

When rotary motions of the servomotors 10 are converted into linear motions by the ball screws 13, therefore, the mounting bases 8 linearly move, guided by the linear guides 7. Further, the movable portion 3 and the movable portion supporting members 9 on the mounting bases 8 also linearly move in a body, guided by the tie bars 6.

First wedges 15 and second wedges 16 are provided between the mounting bases 8 and the movable portion supporting members 9. They serve as adjustment mechanisms for adjusting vertical inclinations of the supporting members 9 with respect to the mounting bases 8. Further, third wedges 17 are provided as adjusting mechanisms for adjusting transverse inclinations.

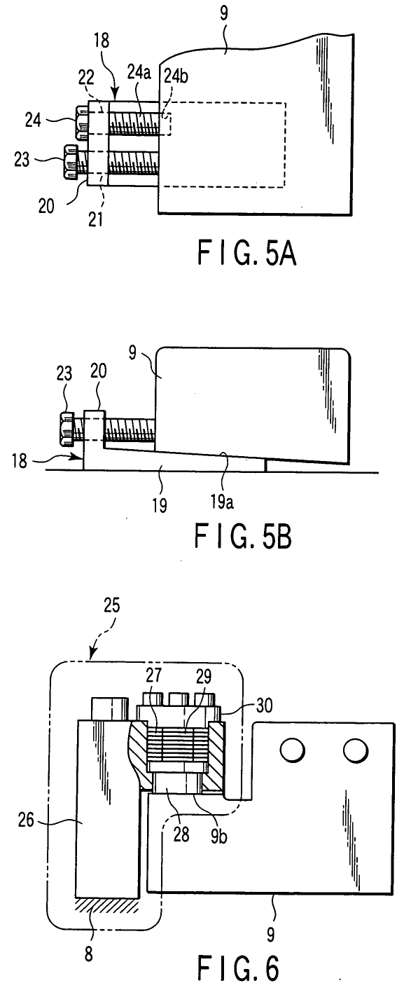

The first to third wedges 15 to 17 have basically the same construction shown in FIGS. 4 and 5. Each wedge body 18 is provided with an insert portion 19 that has a slope 19a. A raised portion 20 is provided integrally on the proximal end part of the insert portion 19. First and second threaded holes 21 and 22 are bored through the raised portion 20. A first bolt 23 is screwed in the first threaded hole 21. The distal end of the bolt 23 abuts against a sidewall of each supporting member 9. A second bolt 24 is screwed in the second threaded hole 22. A threaded portion 24a of the bolt 24 is screwed in a threaded hole 24b in the sidewall of the supporting member 9.

Thus, if the first and second bolts 23 and 24 are loosened and screwed in, respectively, as shown in FIG. 4, the wedge body 18 advances with respect to the movable portion supporting member 9. If the second and first bolts 24 and 23 are loosened and screwed in, respectively, as shown in FIG. 5, on the other hand, the wedge body 18 retreats with respect to the supporting member 9.

As shown in FIGS. 1 to 3, moreover, the first wedges 15 are provided between the left- and right-hand mounting bases 8 and the movable portion supporting members 9 in front of the movable portion 3. Further, the second wedges 16 are provided between the mounting bases 8 and the supporting members 9 at the back of the movable portion 3. Accordingly, the vertical inclinations of the supporting members 9 with respect to the mounting bases 8 can be adjusted by the first and second wedges 15 and 16. Furthermore, each third wedge 17 is provided between a vertical surface 8a of each mounting base 8 and a vertical surface 9a of each supporting member 9. The third wedges 17 are located at right angles to the first and second wedges 15 and 16. Thus, the transverse inclinations of the supporting members 9 with respect to the mounting bases 8 can be adjusted by the third wedges 17.

A first elastic pressure member 25 is provided on the upper surface of each movable portion supporting member 9 that faces each first wedge 15. The pressure member 25 elastically presses the supporting member 9 toward each mounting base 8. As shown in FIG. 6, a spring holder 26 is fixed to the mounting base 8. The spring holder 26 is provided with a spring storage portion 27 in the form of a vertical depression that faces the upper surface of the supporting member 9. The spring storage portion 27 contains a pressure piston 28 and a plurality of coned disc springs 29. The springs 29 are kept compressed by a lid 30 that closes the spring storage portion 27. Thus, the pressure piston 28 elastically presses a load receiving surface 9b of the supporting member 9 by means of the elastic force of the springs 29. In consequence, the left- and right-hand supporting members 9 are downwardly pressed against their corresponding mounting bases 8 by the springs 29.

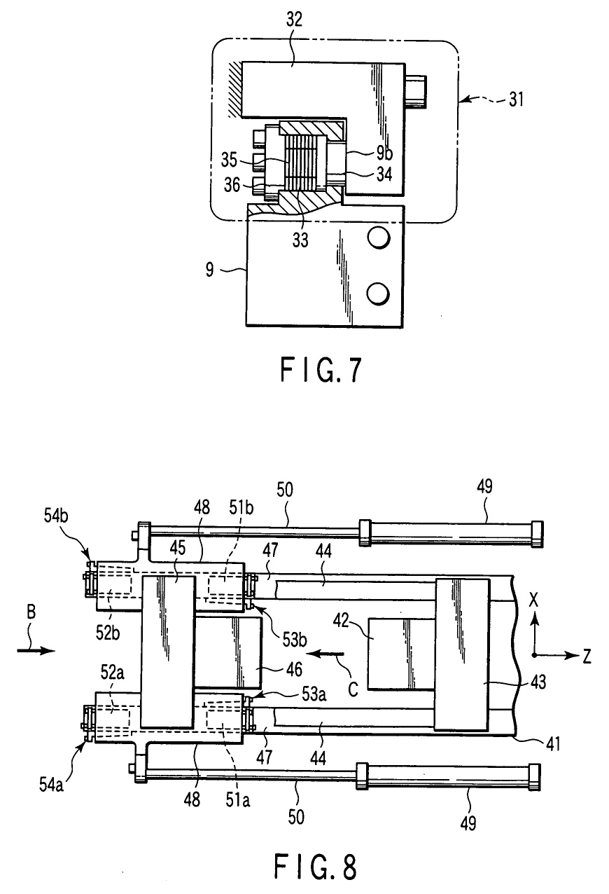

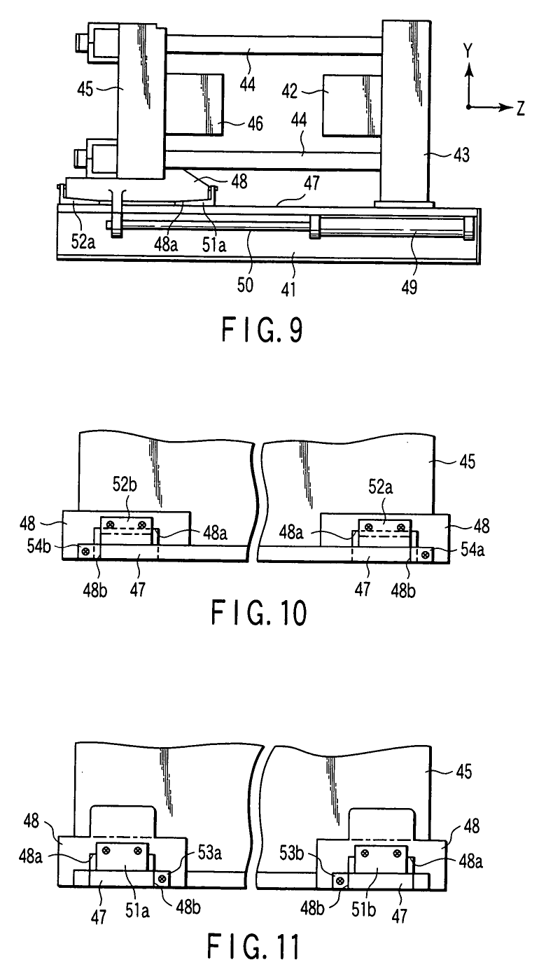

Further, a second elastic pressure member 31 is provided on the front part of each mounting base 8. The pressure member 31 elastically presses each movable portion supporting member 9 rearward or toward its corresponding third wedge 17 so as to face the wedge 17. As shown in FIG. 7, moreover, an L-shaped patch 32 is fixed to the mounting base 8. The patch 32 is provided with the load receiving surface 9b that faces the front face of the supporting member 9.

Each movable portion supporting member 9 is provided with a spring storage portion 33 in the form of a longitudinal depression. The spring storage portion 33 contains a pressure piston 34 and a plurality of coned disc springs 35. The springs 35 are kept compressed by a lid 36 that closes the spring storage portion 33. Thus, the pressure piston 34 elastically presses the load receiving surface 9b of the supporting member 9 by means of the elastic force of the springs 35. In consequence, the left- and right-hand supporting members 9 are transversely pressed against their corresponding mounting bases 8 by the springs 35.

The first and second elastic pressure members 25 and 31 are arranged in pairs, left and right, between the mounting bases 8 and the movable portion supporting members 9. They serve to absorb vertical and transverse deformations, if any, of the movable portion 3. Thus, while the movable portion 3 is allowed to move linearly by means of linear guides 7, it is elastically supported in the left-right and up-down directions by the pressure members 25 and 31 in the vicinity of the linear guides 7. If the movable portion 3 is subjected to any deformations, the deformations are absorbed, so that their influences on the movable portion 3, stationary and movable dies 4 and 5, and linear guides 7 can be reduced.

The following is a description of the operation of the die clamping unit of the injection molding machine constructed in this manner.

The inclination of the movable portion supporting members 9 in an up-down direction α with respect to the mounting bases 8 can be adjusted by the first and second wedges 15 and 16. If the first and second bolts 23 and 24 are loosened and screwed in, respectively, the wedge bodies 18 advance with respect to the movable portion supporting members 9. If the second and first bolts 24 and 23 are loosened and screwed in, respectively, in contrast with this, the wedge bodies 18 retreat with respect to the supporting members 9.

Thus, the inclination of the movable portion supporting members 9 in the up-down direction a can be adjusted by the first and second wedges 15 and 16. Likewise, the left- and right-hand third wedges 17 can adjust the inclination of the supporting members 9 in a left-right direction β with respect to the mounting bases 8 as the first and second bolts 23 and 24 are loosened or tightened. Further, the position of the movable portion 3 can be adjusted at right angles to the linear guides 7. More specifically, the vertical and transverse inclinations of the supporting members 9 can be independently adjusted by the first, second, and third wedges 15, 16 and 17.

Each third wedge 17 is located between the vertical surface 8a of each mounting base 8 and the vertical surface 9a of each movable portion supporting member 9 so as to extend at right angles to the first and second wedges 15 and 16. Even if the third wedges 17 are moved for adjustment, therefore, the movable portion 3 never moves in the up-down direction. Thus, only the inclination of the movable portion supporting members 9 in the left-right direction b with respect to the mounting bases 8 can be adjusted.

Then, in clamping the stationary die 4 on the stationary portion 2 and the movable die 5 on the movable portion 3, the left- and right-hand servomotors 10 are driven simultaneously. Rotary motions of the servomotors 10 are converted into linear motions by the ball screws 13. With these linear motions, the mounting bases 8 move linearly, guided by the linear guides 7. Further, the movable portion 3 and the movable portion supporting members 9 on the mounting bases 8 linearly move in a body, guided by the tie bars 6. Then, the dies 4 and 5 are clamped.

If a given amount of liquid resin is injected through an injection nozzle of the injection molding machine (not shown) after the stationary die 4 and the movable die 5 are clamped, it is filled into a cavity between the dies 4 and 5. When filling the liquid resin is completed, an injection press process is started. More specifically, a high-pressure die clamping force is generated so that the liquid resin in the cavity is pressed at high pressure. Thereafter, dwelling and cooling processes are performed, whereupon a molded product is completed.

If the high-pressure die clamping force is generated by the servomotors 10, in this case, the movable portion 3 inclines in the up-down direction a and then in the left-right direction b. Thereupon, the outer peripheral edge of the movable portion 3 is deformed toward the stationary portion 2, and the movable portion 3 is deformed substantially into the shape of a circular arc as viewed laterally or flat.

As this is done, the inclination of the movable portion 3 in the up-down direction a is absorbed by elastic deformation of the first elastic pressure member 25. Further, the inclination of the movable portion 3 in the left-right direction b is absorbed by elastic deformation of the second elastic pressure member 31. Thus, the movable portion supporting members 9 incline in the up-down and left-right directions. Since the supporting members 9 are independent of the mounting bases 8, however, there is no possibility of any load acting on the mounting bases 8. Even if the supporting members 9 incline in the up-down and left-right directions, therefore, no load can act on the mounting bases 8 that are supported for linear motion by the linear guides 7. Thus, the mounting bases 8 can smoothly slide with respect to the guides 7.

According to the present embodiment, the movable portion 3 can be easily adjusted in the left-right and up-down directions. Further, the movable portion 3 can be independently adjusted in the up-down and left-right directions. Furthermore, the linear guides 7 and the mounting bases 8 can be protected, so that the life of the device can be lengthened.

Although the movable portion 3 and the movable portion supporting members 9 are provided independently of one another in the embodiment described above, they may be formed integrally. Further, the respective positions of each third wedge 17 and its corresponding second elastic pressure member 31 may be replaced with each other.

Furthermore, each second elastic pressure member 31 may be elevated in position so that the upper part of each movable portion supporting member 9 is elastically pressed toward the back of the movable portion 3. In this case, a vertical moment is generated such as to press the supporting member 9 downward. Thus, the first elastic pressure members 25 that elastically press the supporting members 9 toward the mounting bases 8 may be omitted.

Although the die clamping unit of the injection molding machine has been described herein, this invention may be also applied to a die-casting machine, press machine, etc.

This invention is not limited directly to the embodiment described above, and its components may be embodied in modified forms without departing from the scope or spirit of the invention. Further, various inventions may be formed by suitably combining a plurality of components described in connection with the foregoing embodiment. For example, some of the components according to the foregoing embodiment may be omitted. Furthermore, components according to different embodiments may be combined as required.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A supporting device for a movable portion, comprising:
a linear guide and a mounting base configured to move linearly, guided by the linear guide;
the movable portion mounted on the mounting base;
a servomotor having a ball screw which causes the mounting base to move the movable portion linearly; and
a plurality of adjusting mechanism located between the movable portion and the mounting base in front of and/or at the back of the movable portion and configured independently to adjust inclinations of the movable portion in an up-down direction and in a left-right direction within a horizontal plane.

2. A supporting device for a movable portion according to claim 1, wherein the adjusting mechanisms are wedges which are inserted between the movable portion and the mounting base and serve to adjust the inclinations of the movable portion in the up-down direction and in the left-right direction within the horizontal plane, depending on the depth of the insertion.

3. A supporting device for a movable portion according to claim 1, wherein the adjusting mechanisms include wedges which are inserted between the movable portion and the mounting base and serve to adjust the inclinations of the movable portion in the up-down direction and in the left-right direction within the horizontal plane, depending on the depth of the insertion, and elastic pressure members which are opposed to the wedges and elastically press the movable portion toward the mounting base.

4. A supporting device for a movable portion according to claim 2, wherein the wedges include first wedge and second wedge which are located individually in front and at the back of the movable portion and serve to adjust the inclination of the movable portion in the up-down direction and third wedge which are located in front or at the back of the movable portion and serve to adjust the inclination of the movable portion in the left-right direction within the horizontal plane.

5. A supporting device for a movable portion according to claim 3, wherein the wedges include first and second wedges which are located individually in front and at the back of the movable portion and serve to adjust the inclination of the movable portion in the up-down direction and third wedge which are located in front or at the back of the movable portion and serve to adjust the inclination of the movable portion in the left-right direction within the horizontal plane.

6. A die clamping unit which includes die clamping means having a stationary portion fitted with a stationary die and a movable portion attached to the stationary portion by a tie bar for advance and retreat with respect to the stationary die and configuration to move the movable portion to generate a die clamping force when the stationary die and a movable die fixed to the movable portion are to be closed, comprising:
a linear guide and a mounting base configured to move linearly, guided by the linear guide; the movable portion mounted on the mounting base; a servomotor having a ball screw which causes the mounting base to move the movable portion linearly; and a plurality of adjusting mechanism located between the movable portion and the mounting base in front of and/or at the back of the movable portion and configured independently to adjust inclinations of the movable portion in an up-down direction and in a left-right direction within a horizontal plane.

7. A supporting device for a movable portion, in which the movable portion is mounted on a mounting base configured to move linearly, guided by a linear guide, and is supported for linear movement by a servomotor having a ball screw, comprising:
a plurality of adjusting mechanism located between the movable portion and the mounting base in front of and/or at the back of the movable portion and configured independently to adjust inclinations of the movable portion in an up-down direction and in a left-right direction within a horizontal plane.
